(19) United States
(12) Patent Application Publication
(10) Pub. No.: US 2006/0268383 A1
(43) Pub. Date: Nov. 30, 2006

(54) Optical scanner having multi-layered comb electrodes

(75) Inventors: Jin-woo Cho, Seongnam-si (KR); Young-chul Ko, Yongin-si (KR); Jin-ho Lee, Suwon-si (KR); Hyun-ku Jeong, Chungju-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/387,958

(22) Filed: Mar. 24, 2006

(30) Foreign Application Priority Data
May 31, 2005 (KR) 10-2005-0046128

(51) Int. Cl. G02B 26/08; G02B 26/00; H02N 1/00

(52) U.S. Cl. 359/223; 310/309; 359/290

(57) ABSTRACT

Optical scanners having a multi-layered comb electrode structure and methods to increase driving force and angle are provided. The optical scanner includes: a stage which performs a seesaw motion in a first direction; a support unit which supports the seesaw motion of the stage; and a stage driving unit including driving comb electrodes extending outward from opposite sides of the stage in the first direction and fixed comb electrodes extending from the support unit facing the driving comb electrodes such that the driving comb electrodes and the fixed comb electrodes alternate with each other. Each of the stage, the support unit, and the stage driving unit is made of a plurality of conductive layers and insulation layers between the conductive layers.

### CROSS-REFERENCE TO RELATED PATENT APPLICATION

This application claims priority, under 35 U.S.C. § 119, from Korean Patent Application No. 10-2005-0046128, filed on May 31, 2005, in the Korean Intellectual Property Office, the disclosure of which is incorporated herein in its entirety by reference.

### BACKGROUND OF THE INVENTION

1. Field of the Invention

Apparatuses and methods consistent with the present invention relate to a micro-electro-mechanical system (MEMS) optical scanner, and more particularly, to an optical scanner having multi-layered comb electrodes formed on the same plane.

2. Description of the Related Art

Optical scanners can be used for large display devices to scan a laser beam. In optical scanners, the driving speed of an actuator relates to the resolution of a display device, and the driving angle of the optical scanner relates to the screen size of the display device. That is, as the driving speed of the optical scanner increases, resolution increases. Also, as the driving angle of the optical scanner increases, the screen size of the display device increases. Accordingly, in order to realize large display devices with high resolution, optical scanners including an actuator need to operate at high speed and have a high driving angle. However, since the driving speed and the driving angle of the actuator are in a trade-off relation, there is a limitation in increasing both the driving speed and the driving angle of the actuator.

FIG. 1 is a plan view of a conventional optical scanner. FIG. 2 is a cross-sectional view taken along line II-II of FIG. 1. Referring to FIGS. 1 and 2, a stage 1 is suspended above a substrate 5 made of pyrex glass by torsion springs 2 and anchors 6 that support both sides of the stage 1. A plurality of parallel driving comb electrodes 3 having a predetermined length extend from opposite sides of the stage 1. A plurality of parallel fixed comb electrodes 4 are formed on a top surface of the substrate 5 to alternate with the driving comb electrodes 3.

In the conventional optical scanner constructed as above, the stage 1 seesaws due to an electrostatic force between the driving comb electrodes 3 and the fixed comb electrodes 4. For example, when a predetermined voltage Vd₁ is applied to the fixed comb electrodes 4 disposed on the left side around the torsion springs 2, an electrostatic force is generated between the driving comb electrodes 3 and the fixed comb electrodes 4 to drive the driving comb electrodes 3. Accordingly, the stage 1 is moved leftward. When a predetermined voltage Vd₂ is applied to the fixed comb electrodes 4 that are disposed on the right side about the torsion springs 2, an electrostatic force is generated between the driving comb electrodes 3 and the fixed comb electrodes 4 to move that stage 1 rightward. The stage 1 returns to its original position due to the restoring force of the torsion springs 2 having a predetermined elastic coefficient. The stage 1 can seesaw when a driving voltage is repeatedly and alternately applied to the fixed comb electrodes 4 at the left side and at the right side to generate an electrostatic force. When the driving and fixed comb electrodes of the conventional optical scanner are aligned using two wafers, a gap (g) between the fixed comb electrodes and the driving comb electrodes is 4 μm considering an alignment error of 1 μm. Accordingly, the number of the driving comb electrodes formed on the side of the stage 1 is limited, thereby reducing a driving force.

The motion equation of the stage 1 due to the driving force is as follows.
I\ddot{θ}+C\dot{θ}+Kθ=M (1)
where I denotes the moment of inertia of the stage 1, θ denotes a driving angle, C denotes a damping coefficient, K denotes a torsion spring constant, and M denotes a torque produced by a driving voltage.

To increase the driving angle and frequency, the driving force of the comb electrodes must increase. To this end, the distance between the driving comb electrodes and the fixed comb electrodes on the same side of the stage must be reduced to increase the number of the comb electrodes.

### SUMMARY OF THE INVENTION

The present invention provides optical scanners having multi-layered comb electrodes and methods to increase a driving force and a driving angle.

According to an aspect of the present invention, there is provided an optical scanner comprising: a stage which performs a seesaw motion in a first direction; a support unit which supports the seesaw motion of the stage; and a stage driving unit comprising at least one driving comb electrode extending outward from at least one of two opposite sides of the stage in the first direction and at least one fixed comb electrode extending from the support unit facing the driving comb electrode such that the driving comb electrode and the fixed comb electrode alternates with each other, wherein each of the stage, the support unit and the stage driving unit comprises a plurality of conductive layers and insulation layers between the conductive layers.

The number of the conductive layers may be three.

The support unit may comprise: at least one torsion spring extending from at least one of two other opposite sides of the stage in a direction perpendicular to the first direction; and a fixed frame connected to an end of the torsion spring, wherein the fixed comb electrode is extended from at least one of two opposite sides of the fixed frame.

The conductive layers of the driving comb electrodes may be connected to the conductive layers of the torsion spring, respectively, and the conductive layers of the fixed frame may comprise at least three electrically isolated portions so that voltage is separately applied to the driving comb electrode and the fixed comb electrode.

The conductive layers below an uppermost conductive layer among the conductive layers of the fixed frame may extend outward to be exposed, and an electrode pad may be formed on an exposed portion of each of the outwardly extended conductive layers.

Each layer of the driving comb electrodes and each layer of the fixed comb electrodes may be formed vertically at same level.

According to another aspect of the present invention, there is provided an optical scanner comprising: a stage which performs a seesaw motion in a first direction; a first support unit which supports the stage; a stage driving unit comprising a first at least one driving comb electrode extending outward from at least one of two opposite sides of the stage in the first direction and a first at least one fixed comb electrode extending from the first support unit facing the first driving comb electrode such that the first driving comb electrode and the first fixed comb electrode alternates with each other; a second support unit which supports the first support unit such that the first support unit can seesaw in a second direction perpendicular to the first direction; and a first support unit driving unit comprising a second at least one driving comb electrode formed at the first support unit and a second at least one fixed comb electrode formed to correspond to the second driving comb electrode, wherein each of the stage, the first support unit, the stage driving unit, the second support unit and the first support unit driving unit comprise a plurality of conductive layers and insulation layers between the conductive layers.

The first support unit may comprise: at least one first torsion spring extending in the second direction from at least one of two other opposite sides of the stage; and a rectangular movable frame comprising a pair of parallel first portions extending in the first direction to be connected to the first torsion spring and a pair of second portions extending in the second direction.

The second support unit may comprise: at least one second torsion spring extending in the first direction from the second portions of the first support unit; and a rectangular fixed frame comprising a pair of parallel second portions extending in the second direction to be connected to the second torsion spring and a pair of first portions extending in the first direction.

The first support unit driving unit may comprise at least one first extending member extending from the movable frame to be parallel to the second torsion spring, wherein the second driving comb electrode extends from the first extending member toward the first portions of the second support unit, wherein second fixed comb electrode extends from at least one second extending member that extends from the second support unit to correspond to the first extending member.

If the number of the second torsion spring is two, the conductive layers of the first driving comb electrode may be connected to the conductive layers of one of the two second torsion springs, respectively, the conductive layers of the first fixed comb electrode and the second driving comb electrode may be connected to the conductive layers of the other of the two second torsion springs, respectively, and the conductive layers of the second fixed comb electrode may be connected to the conductive layers of the fixed frame, respectively.

According to still another aspect of the present invention, there is provided a method of driving a mirror stage of an optical scanner comprising at least one multi-layered driving comb electrode and at least one multi-layered fixed comb electrode, the method comprising: applying a predetermined voltage to each layer of the driving comb electrode and the fixed comb electrode; and changing the predetermined voltage applied to at least one layer of the driving comb electrode and the fixed comb electrode to increase an electrostatic force between the driving comb electrode and the fixed comb electrode.

### BRIEF DESCRIPTION OF THE DRAWINGS

The above and other features and aspects of the present invention will become more apparent by describing in detail exemplary embodiments thereof with reference to the attached drawings, in which:

FIG. 1 is a plan view of a conventional optical scanner;

FIG. 2 is a cross-sectional view taken along line II-II of FIG. 1;

FIG. 3 is a perspective view of an optical scanner according to an exemplary embodiment of the present invention;

FIG. 4 is a plan view of the optical scanner of FIG. 3;

FIG. 5 is a cross-sectional view taken along line V-V of FIG. 4;

FIGS. 6A through 6C are diagrams for explaining an exemplary operating principle of the optical scanner of FIG. 3;

FIG. 7 is a plan view illustrating exemplary electrical paths of the optical scanner of FIG. 3;

FIG. 8 is a cross-sectional view of electrode pads connected to respective layers of the optical scanner of FIG. 3;

FIG. 9A is a graph illustrating an exemplary capacitance change between a third layer of a driving comb electrode and first to third layers of a fixed comb electrode according to a driving angle;

FIG. 9B is a schematic diagram of a driving comb electrode and a fixed comb electrode;

FIG. 10 is a graph illustrating simulation results when an optical scanner having a single-layered comb electrode structure is driven;

FIG. 11 is a graph illustrating simulation results when the optical scanner having the three-layered comb electrode structure of FIG. 3;

FIG. 12 is a perspective view of an optical scanner according to another exemplary embodiment of the present invention;

FIG. 13 is a plan view of the optical scanner of FIG. 12;

FIG. 14 is a cross-sectional view taken along line XIV-XIV of FIG. 13; and

FIG. 15 is a plan view illustrating electrical paths of the optical scanner of FIG. 12.

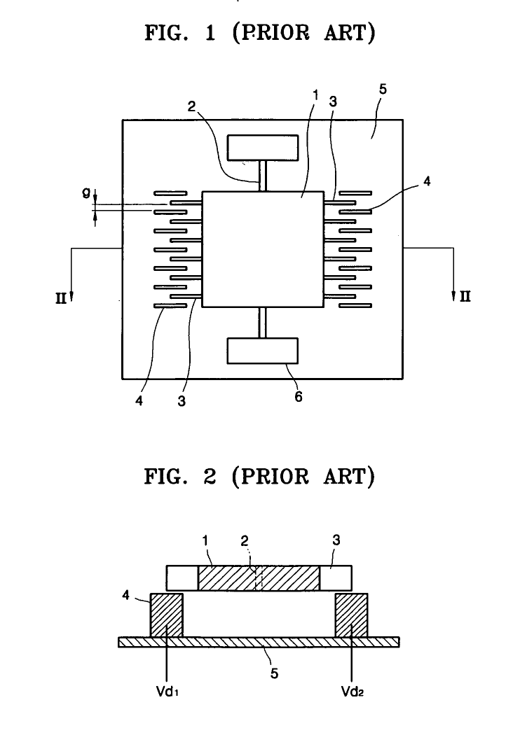

### DETAILED DESCRIPTION OF THE INVENTION

The present invention will now be described more fully with reference to the accompanying drawings, in which exemplary embodiments of the invention are shown. In the following description of the present invention, the sizes of constituent elements shown in the drawings may be exaggerated, if needed, or sometimes the elements may be omitted for a better understanding of the present invention. However, such ways of description does not limit the scope of the technical concept of the present invention.

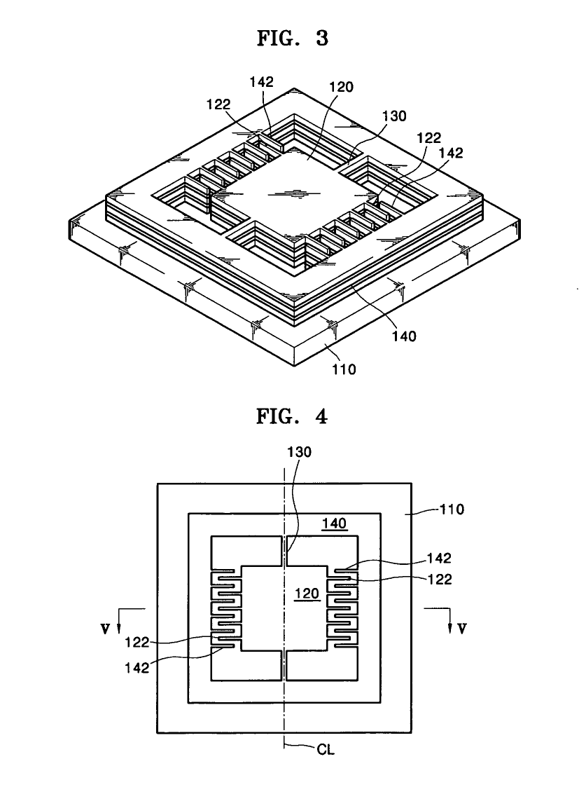

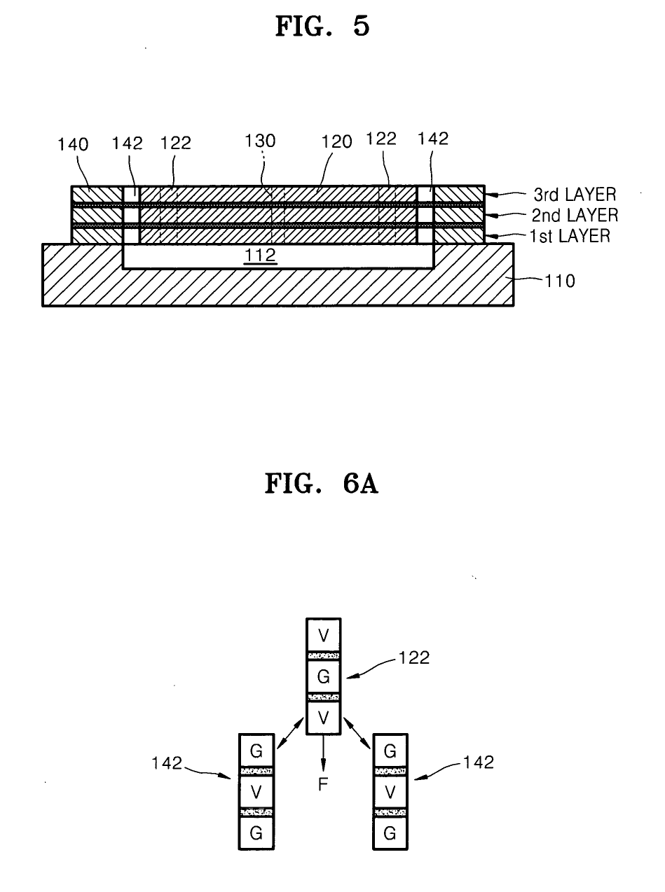

FIG. 3 is a perspective view of an optical scanner according to an exemplary embodiment of the present invention. FIG. 4 is a plan view of the optical scanner of FIG. 3. FIG. 5 is a cross-sectional view taken along line V-V of FIG. 4.

Referring to FIGS. 3 through 5, a stage 120 is suspended above a substrate 110 made of pyrex glass by a support unit that supports both sides of the stage 120. The support unit includes torsion springs 130, which are connected to middle portions of both sides of the stage 120 to support a seesaw motion of the stage 120, and a rectangular fixed frame 140, which enables the torsion springs 130 to be suspended above the substrate 110.

A top surface of the stage 120 is a mirror surface (not shown), i.e., a light scanning surface. A stage driving unit includes a plurality of parallel driving comb electrodes 122 with a predetermined length extending from opposite sides of the stage 120 and a plurality of parallel fixed comb electrodes 142 formed at the fixed frame 140 to alternate with the driving comb electrodes 122. The driving comb electrodes 122 and their corresponding fixed comb electrodes 142 are formed on both sides about a central line CL.

Each of the stage 120, the support unit, and the stage driving unit including the driving comb electrodes 122 and the fixed comb electrodes 142 is formed of three conductive layers, e.g., heavily doped polysilicon layers, and an insulation layer, e.g., an SiO₂ layer, between the heavily doped polysilicon layers. The three conductive layers are referred to as a first layer, a second layer and a third layer from the bottom, for convenience of description.

The comb electrodes of the present exemplary embodiment are disposed on the same plane, and are self-aligned since the comb electrodes are manufactured with one piece of mask when a three-tiered substrate is used. A gap between the driving comb electrodes and the fixed comb electrodes can be reduced because an alignment error of 1 μm caused when two masks are used in the conventional art can be avoided. For example, while a gap between driving comb electrodes and fixed comb electrodes of a conventional optical scanner is 4 μm, a gap between the driving comb electrodes 122 and the fixed comb electrodes 142 of the optical scanner of the present exemplary embodiment is 3 μm. Accordingly, the number of comb electrodes can increase, and thus an electrostatic force produced by the comb electrodes can increase.

The substrate 110 has a space 112 in which the stage 120 can pivot.

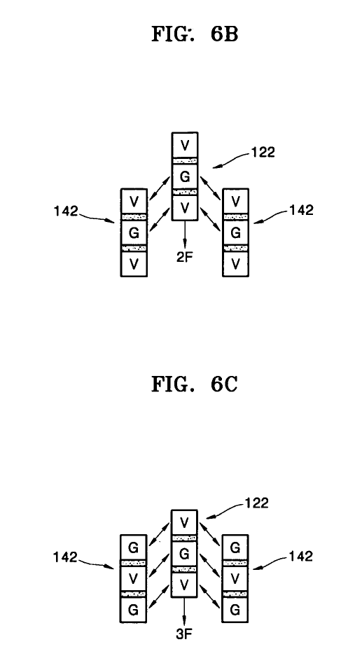

FIGS. 6A through 6C are diagrams for explaining the operating principle of the optical scanner of FIG. 3. The same elements have the same reference numerals.

Referring to FIG. 6A, when a driving comb electrode 122 operates in directions marked by arrows, if a predetermined voltage difference occurs between a third layer of a fixed comb electrode 142 and a first layer of the driving comb electrode 122, an electrostatic force F is generated between the third layer of the fixed comb electrode 142 and the first layer of the driving comb electrode 122. Here, V denotes a predetermined voltage, for example, 300 V DC, and G denotes a ground voltage.

Referring to FIG. 6B, if a voltage applied to the fixed comb electrode 142 is switched when the first layer of the driving comb electrode 122 passes through the third layer of the fixed comb electrode 142, an electrostatic force is generated between the first layer of the driving comb electrode 122 and a second layer of the fixed comb electrode 142, and an electrostatic force is generated between a second layer of the driving comb electrode 122 and the third layer of the fixed comb electrode 142. Accordingly, the magnitude of an electrostatic force 2F generated between the driving comb electrode 122 and the fixed comb electrode 142 is twice that of FIG. 6A.

Referring to FIG. 6C, if a voltage applied to the fixed comb electrodes 142 is switched when the first layer of the driving comb electrode 122 passes through the second layer of the fixed comb electrode 142, an electrostatic force is generated between the first layer of the driving comb electrode 122 and a first layer of the fixed comb electrode 142, between the second layer of the driving comb electrode 122 and the second layer of the fixed comb electrode 142, and between a third layer of the driving comb electrode 122 and the third layer of the fixed comb electrode 142. Accordingly, the magnitude of an electrostatic force 3F generated between the driving comb electrode 122 and the fixed comb electrode 142 substantially is three times that of FIG. 6A. Since the optical scanner having the three-tiered comb electrode structure according to the present exemplary embodiment can generate an electrostatic force three times greater in magnitude than the conventional optical scanner, a driving angle of the optical scanner of the present embodiment can increase.

Although a voltage applied to the fixed comb electrodes is switched in FIG. 6, the present invention is not limited thereto, and the voltage applied to the driving comb electrodes may be switched whereas the voltage applied to the fixed comb electrodes is maintained.

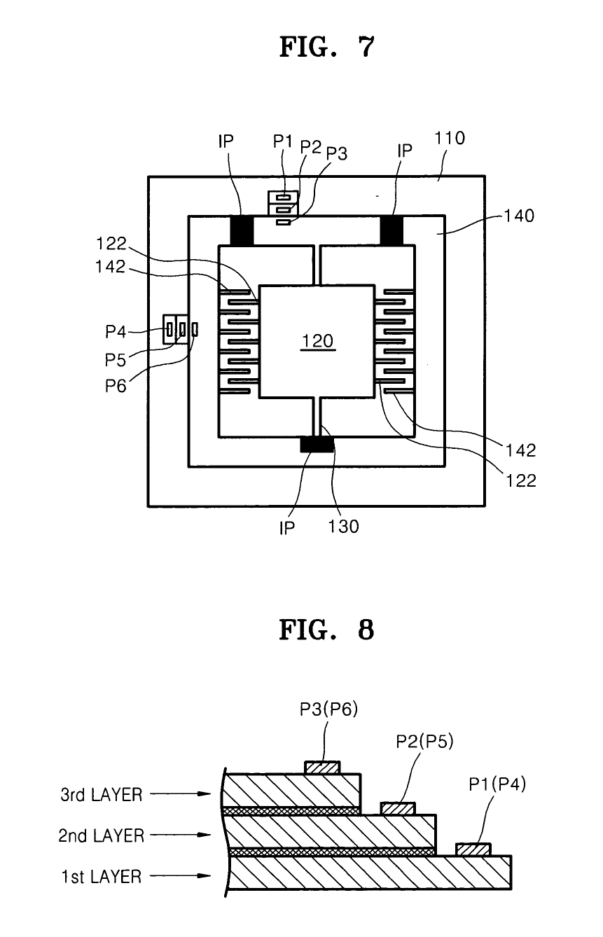

FIG. 7 is a plan view illustrating electrical paths of the optical scanner of FIG. 3. Dark portions, IPs, represent electrically isolated portions, and electrode pads P1 through P6 are provided for connection with external circuits.

The first through third electrode pads P1 through P3 are electrically connected to the first through third layers of the stage 120, respectively. The fourth through sixth electrode pads P4 through P6 are electrically connected to the first through third layers of each of the fixed comb electrodes 142, respectively.

FIG. 8 is a cross-sectional view of the electrode pads connected to the respective layers of the optical scanner of FIG. 3.

Referring to FIG. 8, to form the electrode pads P1 and P2 connected to the first and second layers of each of the driving comb electrodes 122 of the stage 120 and the electrode pads P4 and P5 connected to the first and second layers of each of the fixed comb electrodes 142, the first and second layers extend to be exposed, and the electrode pads P1, P2, P4, ad P5 are formed on the exposed portions of the layers. That is, layers below the third layer among the conductive layers extend outwardly to be exposed and the electrode pads P1, P2, P4, and P5 are installed on the exposed portions of the conductive layers. In the electrode pad arrangement of FIG. 7, a first voltage, a second voltage and the first voltage are respectively applied to the first through third layers of the driving comb electrodes 122, and a first voltage, a second voltage and the first voltage, or a second voltage, a first voltage and the second voltage are respectively applied to the first through third layers of the fixed comb electrodes 142 according to the position of the fixed comb electrode 142. Accordingly, a voltage applied to the fixed comb electrodes 142 is switched.

In order to switch the voltages applied to the fixed comb electrodes 142, means for measuring the position of the driving comb electrode 122 is required. That is, there is needed means for measuring a time when the first layer of the driving comb electrode 122 in FIG. 6B passes through the third layer of the fixed comb electrode 142 and reaches the second layer of each of the fixed comb electrodes 142 and switching the voltages applied to the fixed comb electrode 142.

A capacitance measuring circuit (not shown) which measures a capacitance between layers of the driving comb electrodes 122 and layers of the fixed comb electrodes 142 can be used as the means for measuring the positions of the driving comb electrodes 122.

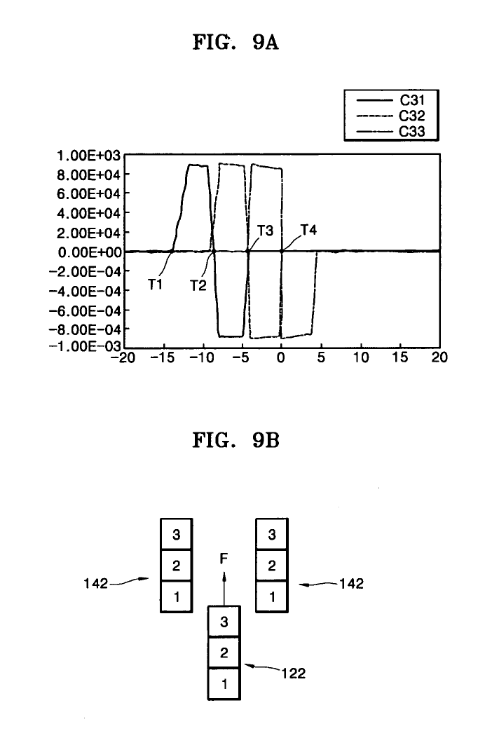

FIG. 9A is a graph illustrating a capacitance change rate between a third layer of a driving comb electrode 122 and first to third layers of a fixed comb electrode 142 according to the driving angle of the driving comb electrode 122. FIG. 9B is a schematic diagram of a driving comb electrode 122 and a fixed comb electrode 142. In FIG. 9B, numbers “1, 2, and 3” denote respective layers of the driving comb electrode 122 and the fixed comb electrode 142.

Referring to FIGS. 9A and 9B, a capacitance C31 between the third layer of the driving comb electrode 122 and the first layer of the fixed comb electrode 142 increases at a point T1 when they meet together, and a capacitance change rate decreases from a time T2 when an upper portion of the driving comb electrode 122 passes through an upper portion of the first layer of the fixed comb electrode 142. A capacitance C31 at a point T2 becomes zero (0). At this time, a voltage applied to the fixed comb electrode 142 is switched to generate an electrostatic force between the third layer of the driving comb electrode 122 and the second layer of the fixed comb electrode 142 and between the second layer of the driving comb electrode 122 and the first layer of the fixed comb electrode 142. The time T2 is almost the same as a time when a capacitance C32 between the third layer of the driving comb electrode 122 and the second layer of the fixed comb electrode 142 begins to rise.

In the same manner, if the voltage applied to the fixed comb electrode 142 is switched at a time T3 when the capacitance C32 between the third layer of the driving comb electrode 122 and the second layer of the fixed comb electrode 142 becomes zero (0) and a time T4 when a capacitance C33 between the third layer of the driving comb electrode 122 and the third layer of the fixed comb electrode 142 becomes zero (0), a driving force between the driving comb electrode 122 and the fixed comb electrode 142 can be maximized.

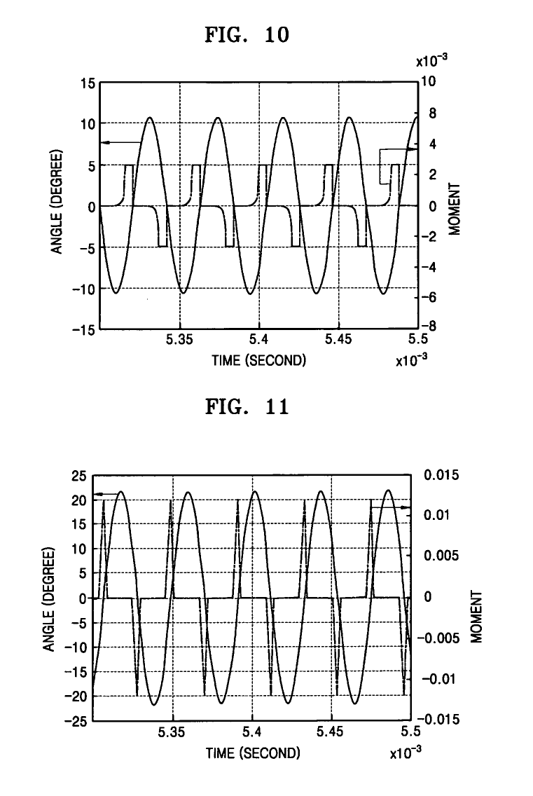

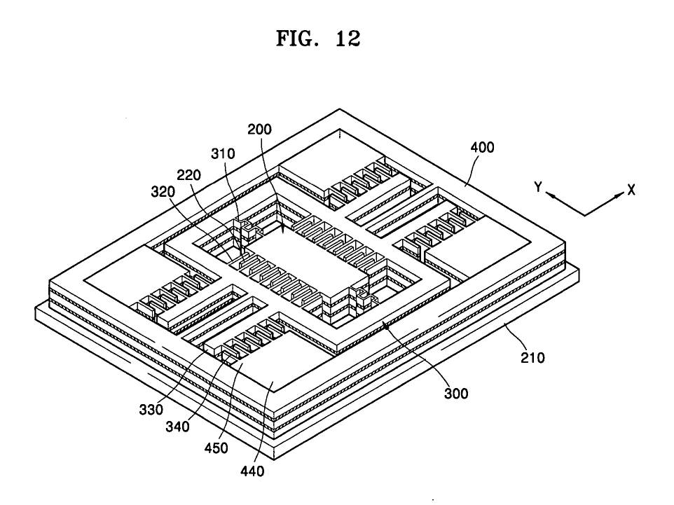

FIG. 10 is a graph illustrating simulation results in a case of driving an optical scanner having a single-layered comb electrode structure. FIG. 11 is a graph illustrating simulation results in a case of driving the optical scanner having the three-layered comb electrode structure of FIG. 3.

Referring to FIG. 10, when the conventional optical scanner is driven at a driving voltage of 300 V and a resonant frequency of 22.5 kHz, a driving angle is 9.5° and the moment of rotation is 2.6×10⁻³ N·mm.

Referring to FIG. 11, when the optical scanner of FIG. 3 is driven at a driving voltage of 300 V and a resonant frequency of 22.5 kHz, a driving angle is 21.7° and the moment of rotation is 12.5×10⁻³ N·mm. Accordingly, the optical scanner of the present exemplary embodiment has a greater driving angle and a greater driving force than the conventional optical scanner.

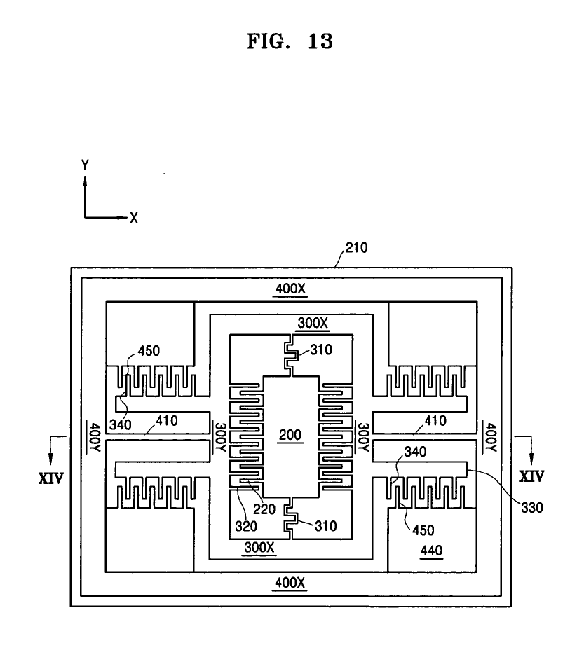

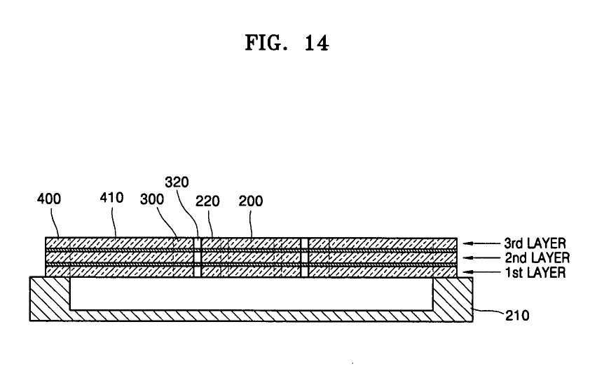

FIG. 12 is a perspective view of an optical scanner according to another exemplary embodiment of the present invention. FIG. 13 is a plan view of the optical scanner of FIG. 12. FIG. 14 is a cross-sectional view taken along line XIV-XIV of FIG. 13.

Referring to FIGS. 12 through 14, a stage 200 is suspended above a substrate 210 made of pyrex glass by a first support unit that supports both sides of the stage 200. The stage 200 can seesaw in a first direction, e.g., X direction, by means of the first support unit that includes first torsion springs 310 and a rectangular movable frame 300. The first torsion springs 310 may be meander springs.

The first support unit can seesaw in a second direction, e.g., Y direction, perpendicular to the first direction by means of a second support unit that includes second torsion springs 410 and a rectangular fixed frame 400. Accordingly, the stage 200 can move in two directions by means of the first support unit and the second support unit.

In detail, the stage 200 is connected to the rectangular movable frame 300 by the two first torsion springs 310 that are formed in the second direction. Accordingly, the stage 300 can seesaw about the first torsion springs 310.

The rectangular movable frame 300 includes two first portions 300X which extend in the first direction and have middle portions to which the first torsion springs 310 are connected, and two second portions 300Y which extend in the second direction and have middle portions to which the second torsion springs 410 are connected. The rectangular fixed frame 400 having first portions 400X extending in the first direction and second portions 400Y extending in the second direction surrounds the rectangular movable frame 300. The fixed frame 400 and the movable frame 300 are connected to each other in such a manner that the second torsion springs 410 are connected to the middle portions of the second portions 300Y and 400Y of the movable frame 300 and the fixed frame 400, respectively. The second torsion springs 410 extend in the first direction, and thus the movable frame 300 can seesaw about the second torsion springs 410.

A stage driving unit for seesawing the stage 200 includes first driving comb electrodes 220 extending from the stage 200 and first fixed comb electrodes 320 extending from the movable frame 300 to alternate with the first driving comb electrodes 220. The comb electrodes are formed vertically, and the corresponding comb electrodes are formed at the same level in a vertical plane.

A first support unit driving unit is disposed between the movable frame 300 and the fixed frame 400. First extending members 330 are formed on both sides of the second torsion springs 410 to extend from the second portion 300Y of the movable frame 300 toward the second portion 400Y of the fixed frame 400 facing the second portion 300Y of the movable frame 300. Second driving comb electrodes 340 are formed at the first extending members 330. Second driving comb electrodes 440 extend from the fixed frame 400 to correspond to the first extending members 330. Second fixed comb electrodes 450 corresponding to the second driving comb electrodes 340 are formed on side surfaces of the second extending members 440 facing the first extending members 330. The comb electrodes 340 and 450 alternate with each other as shown in FIG. 13.

Each of the stage 200, the first support unit, the stage driving unit, the second support unit, and the first support unit driving unit includes three conductive layers, e.g., heavily doped polysilicon layers, and an insulation layer, e.g., an SiO₂ layer, between the polysilicon layers. The three conductive layers are referred to as a first layer, a second layer and a third layer in a bottom-up way, for convenience of description.

In the optical scanner of the present exemplary embodiment illustrated in FIG. 12, the comb electrode structure is easily manufactured by patterning a multi-layered substrate, thereby easily forming electrical paths to respective conductive layers.

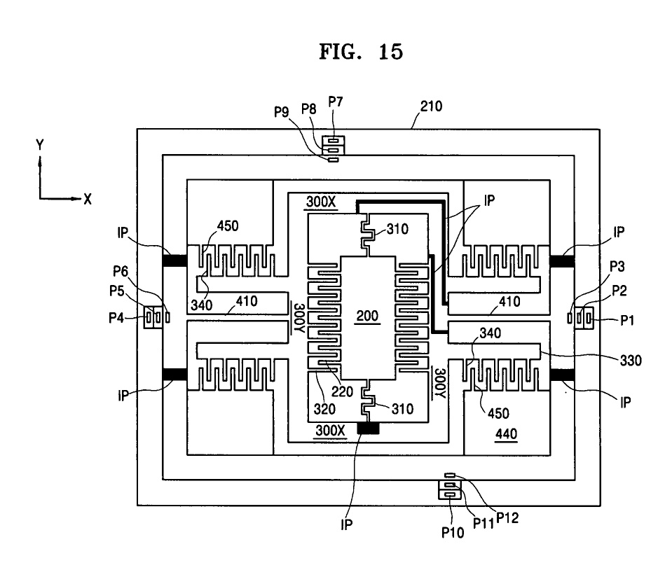

FIG. 15 is a plan view illustrating electrical paths through which a voltage is separately applied to the multi-conductive layers to ensure the biaxial motion of the stage 300 and enhance a driving force. Dark portions, IPs, represent electrically isolated portions, and electrode pads P1 through P12 are provided for connection with external circuits.

Referring to FIG. 15, first through third electrode pads P1 through P3 are respectively connected to the layers of each of the first driving comb electrodes 220 through the layers of the torsion spring 410. Fourth through sixth electrode pads P4 through P6 are electrically connected to the first through third layers of the first fixed comb electrodes 320 and the second driving comb electrodes 340. Seventh through ninth electrode pads P7 through P9 and tenth through twelfth electrode pads P10 through P12 are respectively connected to the layers of the second fixed comb electrodes 450.

In the electrode pad arrangement of FIG. 15, a first voltage, a second voltage and the first voltage are fixedly applied to the first through third layers of each of the first fixed comb electrodes 320 and the second driving comb electrodes 340, and a first voltage, a second voltage and the first voltage, or a second voltage, a first voltage and the second voltage are switched into a high frequency voltage at the first through third layers of each of the first driving comb electrodes 220. A low frequency switching voltage is applied to the first through third layers of each of the second fixed comb electrodes 450. Accordingly, the optical scanner in which a high frequency switching voltage is applied to the first driving comb electrodes 220 and a low frequency switching voltage is applied to the second fixed comb electrodes 450 can be used as an image scanner for a flat panel display.

To switch the applied voltage, means for measuring positions of the first and second driving comb electrodes 220 and 340 is required. As the means for measuring the positions of the first and second driving comb electrodes 220 and 340, a capacitance measuring circuit (not shown) may be used to measure a capacitance between the layers of each of the first and second driving comb electrodes 220 and 340 and the layers of each of the first and second fixed comb electrodes 320 and 450.

Since the operation of the optical scanner illustrated in FIG. 12 is easily understood from the operation of the optical scanner illustrated in FIG. 3, a detailed description thereof will not be given.

Since the optical scanner according to the present invention has the multi-layered comb electrode structure at the same level in the vertical plane, the comb electrodes can be formed using one mask. Accordingly, the gap between the comb electrodes can be reduced and the number of the comb electrodes can be increased.

Also, an electrostatic force between the multi-layered comb electrodes can be increased by switching a voltage applied to the multi-layered comb electrodes. The increase in the driving force can lead to an increase in a driving angle.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An optical scanner comprising:
a stage which performs a seesaw motion in a first direction;
a support unit which supports the seesaw motion of the stage; and
a stage driving unit comprising at least one driving comb electrode extending outward from at least one of two opposite sides of the stage in the first direction and at least one fixed comb electrode extending from the support unit facing the driving comb electrode such that the driving comb electrode and the fixed comb electrode alternates with each other,
wherein each of the stage, the support unit and the stage driving unit comprises a plurality of conductive layers and insulation layers between the conductive layers.

2. The optical scanner of claim 1, wherein the number of the conductive layers is three.

3. The optical scanner of claim 1, wherein each layer of the driving comb electrode and each layer of the fixed comb electrode are formed vertically at the same level.

4. The optical scanner of claim 3, wherein:
a predetermined voltage is applied to the each layer of the driving comb electrode and the fixed comb electrode; and
the predetermined voltage applied to at least one layer of the driving comb electrode and the fixed comb electrode is changed to increase an electrostatic force between the driving comb electrode and the fixed comb electrode.

5. The optical scanner of claim 4, further comprising a circuit which measures a position of the driving comb electrode.

6. The optical scanner of claim 5, wherein the circuit comprises a capacitance measuring circuit which measures a capacitance between predetermined layers of the driving comb electrode and the fixed comb electrode, whereby a distance between the predetermined layers is measured.

7. The optical scanner of claim 1, wherein the support unit comprises:
at least one torsion spring extending from at least one of two other opposite sides of the stage in a direction perpendicular to the first direction; and
a fixed frame connected to an end of the torsion spring,
wherein the fixed comb electrode is extended from at least one of two opposite sides of the fixed frame.

8. The optical scanner of claim 7, wherein:
the conductive layers of the driving comb electrode are connected to the conductive layers of the torsion spring, respectively; and
the conductive layers of the fixed frame comprise at least three electrically isolated portions so that voltage is separately applied to the driving comb electrode and the fixed comb electrode.

9. The optical scanner of claim 1, wherein the conductive layers of the driving comb electrode are electrically isolated from the conductive layers of the fixed comb electrode.

10. The optical scanner of claim 1, wherein conductive layers below an uppermost conductive layer among the conductive layers of the fixed frame extend outward to be exposed, and an electrode pad is formed on an exposed portion of each of the outwardly extended conductive layers.

11. An optical scanner comprising:
a stage which performs a seesaw motion in a first direction;
a first support unit which supports the stage;
a stage driving unit comprising a first at least one driving comb electrode extending outward from at least one of two opposite sides of the stage in the first direction and a first at least one fixed comb electrode extending from the first support unit facing the first driving comb electrode such that the first driving comb electrode and the first fixed comb electrode alternates with each other;
a second support unit which supports the first support unit such that the first support unit can seesaw in a second direction perpendicular to the first direction; and
a first support unit driving unit comprising a second at least one driving comb electrode formed at the first support unit and a second at least one fixed comb electrode formed to correspond to the second driving comb electrode,
wherein each of the stage, the first support unit, the stage driving unit, the second support unit and the first support unit driving unit comprises a plurality of conductive layers and insulation layers between the conductive layers.

12. The optical scanner of claim 11, wherein the number of the conductive layers is three.

13. The optical scanner of claim 11, wherein each layer of the first and second driving comb electrodes and each layer of the first and second fixed comb electrodes are formed vertically at the same level.

14. The optical scanner of claim 13, wherein
a predetermined voltage is applied to the each layer of the first and second driving comb electrodes and the first and second fixed comb electrodes; and
the predetermined voltage applied to at least one layer of the first and second driving comb electrodes and the first and second fixed comb electrode is changed to increase at least one of an electrostatic force between the first driving comb electrode and the first fixed comb electrode, and an electrostatic force between the second driving comb electrode and the second fixed comb electrode.

15. The optical scanner of claim 14, further comprising a circuit which measures a position of at least one of the first and second driving comb electrodes.

16. The optical scanner of claim 15, wherein the circuit comprises at least one capacitance measuring circuit which measures a capacitance between predetermined layers of the first and second driving comb electrodes and the first and second fixed comb electrodes, whereby a distance between the predetermined layers is measured.

17. The optical scanner of claim 11, wherein the first support unit comprises:
at least one first torsion spring extending in the second direction from at least one of two other opposite sides of the stage; and
a rectangular movable frame comprising a pair of parallel first portions extending in the first direction to be connected to the first torsion spring and a pair of second portions extending in the second direction.

18. The optical scanner of claim 17, wherein the second support unit comprises:
at least one second torsion spring extending in the first direction from the second portions of the first support unit; and
a rectangular fixed frame comprising a pair of parallel second portions extending in the second direction to be connected to the second torsion spring and a pair of first portions extending in the first direction.

19. The optical scanner of claim 18, wherein the first support unit driving unit comprises at least one first extending member extending from the movable frame to be parallel to the second torsion spring,
wherein the second driving comb electrode extends from the first extending member toward the first portions of the second support unit,
wherein the second fixed comb electrode extends from at least one second extending member extending from the second support unit to correspond to the first extending member.

20. The optical scanner of claim 18,
wherein there are two second torsion springs, each being extended in the first direction from each of the second portions of the first support unit, respectively, wherein:
the conductive layers of the first driving comb electrode are connected to the conductive layers of one of the two second torsion springs, respectively;
the conductive layers of the first fixed comb electrode and the second driving comb electrode are connected to the conductive layers of the other of the two second torsion springs, respectively; and
the conductive layers of the second fixed comb electrode are connected to the conductive layers of the fixed frame, respectively.

21. The optical scanner of claim 1 1,
wherein the conductive layers of the first driving comb electrode, the first fixed comb electrode and the second fixed comb electrode are electrically isolated from one another,
wherein the conductive layers of the first fixed comb electrode and the second driving comb electrode are electrically connected to one another.

22. The optical scanner of claim 11, wherein:
a high frequency switching voltage is applied to the first driving comb electrode;
a fixed voltage is applied to the first fixed comb electrode and the second driving comb electrode; and
a low frequency switching voltage is applied to the second fixed comb electrode.

23. The optical scanner of claim 11, wherein conductive layers below an uppermost conductive layer among the conductive layers of the fixed frame extend outward to be exposed, and an electrode pad is formed on an exposed portion of each of the outwardly extended conductive layers.

24. A method of driving a mirror stage of an optical scanner comprising at least one multi-layered driving comb electrode and at least one multi-layered fixed comb electrode, the method comprising:
applying a predetermined voltage to each layer of the driving comb electrode and the fixed comb electrode; and
changing the predetermined voltage applied to at least one layer of the driving comb electrode and the fixed comb electrode to increase an electrostatic force between the driving comb electrode and the fixed comb electrode.

25. The method of claim 24:
wherein the driving comb electrode and the fixed comb electrode comprise three conductive layers;
wherein applying the predetermined voltage comprises:
applying a first voltage to first and third layers of the driving comb electrode and a second voltage to a second layer of the driving comb electrode; and
applying a third voltage to first and third layers of the fixed comb electrode and a fourth voltage to a second layer of the fixed comb electrode; and
wherein changing the predetermined voltage comprises at least one of:
switching the first and second voltages to each other; and
switching the third and fourth voltages to each other.

26. The method of claim 24, further comprising measuring a position of the driving comb electrode to determine when to change the predetermined voltage.

27. The method of claim 26, wherein measuring of the position of the driving comb electrode comprises measuring a capacitance between predetermined layers of the driving comb electrode and the fixed comb electrode, whereby a distance between the predetermined layers is measured.
